(19) United States
(12) Patent Application Publication
(10) Pub. No.: US 2022/0296979 A1
(43) Pub. Date: Sep. 22, 2022

(54) SYSTEM FOR CONVERTING PEDAL ASSIST BIKE INTO A SMART TRAINER AND A BATTERY CHARGER

(71) Applicant: Rayvolt Inc, Dover, DE (US)

(72) Inventor: Mathieu Rauzier, Barcelona (ES)

(21) Appl. No.: 17/205,083

(22) Filed: Mar. 18, 2021

(51) Int. Cl. A63B 69/16; A63B 24/00

(52) U.S. Cl. CPC A63B 69/16; A63B 24/0062; B62J 45/411

(57) ABSTRACT

This present invention relates to an E-bike built for daily commuting with a special software allowing the E-bike to be converted into a high-end smart trainer using the regenerative brake torque as a resistance in order to work out and recharge the battery. The software/application allows to control the resistance in real time and read all the data in order to create a custom workout routine while charging the battery. The E-bike can be connected to third party virtual cycling software through the ANT+ protocol to maximize the potential.

### BACKGROUND

The present invention relates generally to the field of Electric bikes. More specifically, the present invention relates to a unique designed electric bike that allows the use of motor electromagnetic field, hall sensors, cadence sensors, torque sensors and more to convert the pedal assisted bike into an indoor smart trainer, and broadcast all the fitness data to the cycling simulators. The electric bike of the present invention is used for generating electricity and recharging the battery of the electric bike, while performing the fitness activities. Accordingly, this disclosure makes specific reference thereto the present invention. Nonetheless, it is to be appreciated that aspects of the present invention are also equally applicable to other like applications, devices and methods of manufacture.

By way of background, various kinds of fitness smart trainers have been known for a few years and are used by people around the world. People such as fitness enthusiasts use the smart trainers to improve their training and fitness. The smart trainer is a tool on which the typical bike is mounted while the bike is in use for fitness activities. Conventional fitness bikes comprise a variety of sensors which collect and track fitness data, and supports ANT+FEC protocol to connect the electric bikes to cycling simulators in order to broadcast resistance, speed, cadence and power. Usually, fitness bikes require power supply to support various features and make the device operable. Either a continuous power supply is provided using power supply cords, or the batteries are recharged frequently to provide sufficient power supply for the operation of the fitness bikes. The typical electric bike trainers consume energy instead of creating energy, and cannot be used for any other purpose other than indoor cycling.

Various solutions are provided in the state of the art to overcome the power consumption drawbacks of the currently available fitness smart trainers. For example, indoor bikes using electromagnetic field to generate energy have been around as well. However, these electromagnetic field based indoor bikes are purely designed to generate power.

Another solution to manage the power needs of the fitness smart trainers is Regenerative braking mechanism. The implementation of regenerative braking technology into the conventional electric bikes has been around as well. The regenerative braking is an adaptation of formula one KERS (kinetic energy recovery system) and is an energy recovery mechanism that slows down a moving vehicle or object by converting its kinetic energy into a form that can be either used immediately or stored until needed. The regenerative braking mechanism captures the kinetic energy during deceleration, stores it in the battery so it can be used as electricity to power the electric motor. Usually, regenerative brake on an electric bike is activated by a sensor built into the brake lever that sends a signal to the controller activating the preset brake torque. However, this feature is preset by factory and cannot be adjusted on the fly.

Therefore, there exists a long felt need in the art for an electric bike which can be used for improving fitness of the users. Additionally, there is a long felt need in the art for an electric bike which can be used for other purposes apart from indoor cycling. Moreover, there is a long felt need in the art for an electric bike with a compatible application which enables the users to easily monitor and track their fitness data. There is a long felt need in the state of the art for an electric bike which works on creating energy and not on consuming energy. Further, there is a long felt need in the art for an electric bike which can generate electricity to power its battery. Furthermore, there is a long felt need in the art for an electric bike which is not dependent on factory settings for power generation. Finally, there is a long felt need in the art for a modified electric bike which can be used as normal electric bike as well as a trainer bike or indoor cycling bike.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a system to convert an E-bike into a smart trainer comprising an E-bike having at least a controller, a cadence sensor, a hall sensor, a battery, a brake sensor, a motor and a torque sensor;

a UART capable dongle to communicate with the controller wherein the dongle is used for converting controller data into ANT+ FEC standard; a smartphone application connected to the controller using a Bluetooth Low Energy connection; and the UART capable dongle transfers data between the controller and a virtual cycling simulator.

In a further embodiment of the present invention, a method to convert an E-bike into a smart trainer is disclosed and comprising the steps of using a regenerative brake torque as a resistance for working out and as a resistance for recharging the battery of the E-bike; and connecting the E-bike to a third-party virtual cycling software through the ANT+ protocol.

The present invention provides a solution allowing a user to have an E-bike to be used for daily commuting to be converted into a power generator as well as a smart training machine broadcasting all the fitness data found on the most high-end machines.

This invention allows a user to use a generic E-bike mounted onto a stand in order to keep rear wheel free to roll, connecting the bike through BLE to a smartphone application such as the RegenFit™ APP and recharging the battery of the E-bike while doing the inAPP fitness programs or broadcasting data to a third party cycling simulator and converting data to the standard ANT+ FEC protocol.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates an E-bike nomenclature and the common E-bike hardware used combined with a RegenFit dongle and a mobile application of the present invention as per the disclosed structure;

FIG. 2 illustrates a Bluetooth connection between RegenFit App and Controller to transfer data and instruction during the boot of the controller and during workout as per the disclosed architecture;

FIG. 3 illustrates a communication from controller of E-bike to a 3rd party Cycling Simulator via RegenFit Dongle of the present invention;

FIG. 4 illustrates a communication from a 3rd party Cycling Simulator via RegenFit Dongle to a controller of E-bike of the present invention;

FIG. 5 illustrates a perspective view showing charging of battery of E-bike using electromagnetic field of the motor as per the disclosed structure;

FIG. 6 illustrates a perspective view showing different interfaces of the RegenFit App used in the present invention as per the disclosed structure; and

FIG. 7 illustrates control flow diagram between various components of the system of the present invention as per the disclosed structure.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

The present invention, in one exemplary embodiment, is a system to convert an E-bike into a smart trainer comprising an E-bike having at least a controller, a cadence sensor, a hall sensor, a battery, a brake sensor, a motor and a torque sensor; a UART capable dongle to communicate with the controller wherein the dongle is used for converting controller data into ANT+ FEC standard; the E-bike is mounted onto a stand in order to keep rear wheel free to roll, a smartphone application connected to the controller using a Bluetooth Low Energy connection; and the UART capable dongle transfers data between the controller and a virtual cycling simulator.

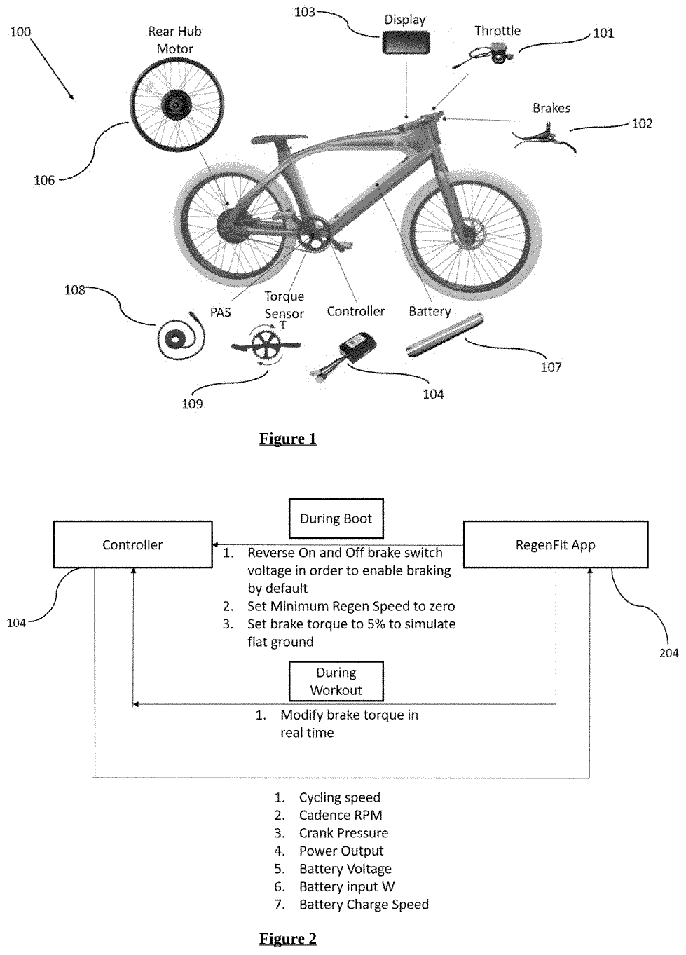

Referring initially to the drawings, FIG. 1 illustrates an E-bike nomenclature and the common E-bike hardware used combined with a RegenFit dongle and a mobile application of the present invention as per the disclosed structure. The E-bike used in the present invention has a rear hub motor 106, a battery 107, a cadence sensor 108, an integrated torque sensor 109 measuring how hard a user is pedaling, a brake sensor 102, a throttle 101 which can be fine-tuned like a volume dial between low and full power and a display 103 to display the activity and other cycling information of a user. The cadence sensor 108 is situated at the crank on an electric bike and sends the cadence in the same way as normal E-bike. The torque sensor 109 sends the crank pressure in the same way as a normal E-bike. The hall sensors (not shown) send the hub motor 106 RPM in the same way as other E-bikes.

In the present invention, a smart controller 104 such as a Rayvolt™ smart controller is added to the E-bike which has ready firmware to RegenFit. The controller 104 is connected to a companion smartphone application RegenFit APP via Bluetooth Low Energy (BLE). A display UART connector connects to a RegenFit dongle fitted in the E-bike. The battery port sends the voltage, Power output and Current discharge which is converted to Power Input and Current Charge by simply converting negative result into a positive result. The hub motor used in the present invention outputs a 3-Phases motor current which is normally used to generate power switching the various copper coils polarity in order to be chasing the magnets.

The brake sensor 102 acts as a switch and sends back a voltage back to controller 104 in the same way as other E-bikes. In the preferred embodiment, the Brake Off voltage of 3.7V when lever is idle and Brake ON voltage of 0V when lever is pulled.

As stated earlier, the controller 104 is connected to a companion smartphone application RegenFit APP via Bluetooth Low Energy (BLE). The RegenFit APP is connected to the controller 104 and alter the controller 104 settings as soon as the controller 104 boots by switching the Brake OFF voltage to Zero Volt so that the engine is cut off and regenerative break torque is permanently ON while RegenFit APP is connected.

In the preferred embodiment, Regenerative breaking in the E-bike is activated only for speed beyond 5 km/h so the RegenFit APP changes the Regenerative breaking parameter to zero. The Brake torque is normally set to 30% of rated power, and the RegenFit app changes the default parameter to 5% which simulate flat road resistance. The RegenFit APP used in the present invention reads all the data received from the controller 104 and converts them to relevant fitness data. The RegenFit APP can automatically adjust resistance (brake torque) in real time according to the exercise program, Interval, Endurance, Cardio etc.

It should be appreciated that Cadence speed in RPM tells the cycling speed and aerobic performance, Crank pressure in Nm tells the Anaerobic performance. Since the controller 104 has BLE, thus, 3rd party heart rate monitors can be paired for additional information such as heart rate, BPM, calories information etc.

An important feature of the present invention is that the RegenFit APP displays the power input of the battery 107 in Watts which paired with a timer can give the capacity recovery in Watthours. The Current Input in Amp give another charge speed indication that compare directly with standard AC/DC charger.

The E-bike of the present invention can be used as a smart training machine broadcasting the fitness data. 3^{rd} party cycling simulators can also be used with the E-bike for training purpose. The RegenFit Dongle translates all the fitness related data from the APP and translate them into the smart trainer ANT+ FEC communication protocol. Using the ANT+ Speed & Cadence protocol, Wheel RPM and pedal cadence are sent to 3rd Party software in one channel, the Brake torque control are sent and received through another channel with the ANT+ Bicycle Power protocol. This conversion allows to receive resistance criteria according to Virtual Cycling APP hills and slopes to translate directly into regenerative brake power on the ebike.

FIG. 2 illustrates a Bluetooth connection between RegenFit App and Controller to transfer data and instruction during the boot of the controller and during workout as per the disclosed architecture. As shown, during boot of the controller 104, the RegenFit App 204 sends instructions to the controller to control the operation of the E-bike. The RegenFit App 204 sends instructions for Reverse On and Off brake switch voltage in order to enable braking by default, setting Minimum Regen Speed to zero, and setting brake torque to 5% to simulate flat ground.

During workout of a user on the E-bike, the RegenFit App 204 sends instruction to the controller 104 to modify brake torque in real time according to the workout such as interval, cardio or endurance.

Similarly, the controller 104 sends real-time information related to cycling speed, Cadence RPM, Crank Pressure, Power Output, Battery Voltage, Battery input W, Battery Charge Speed to the RegenFit App 204 for recording and display.

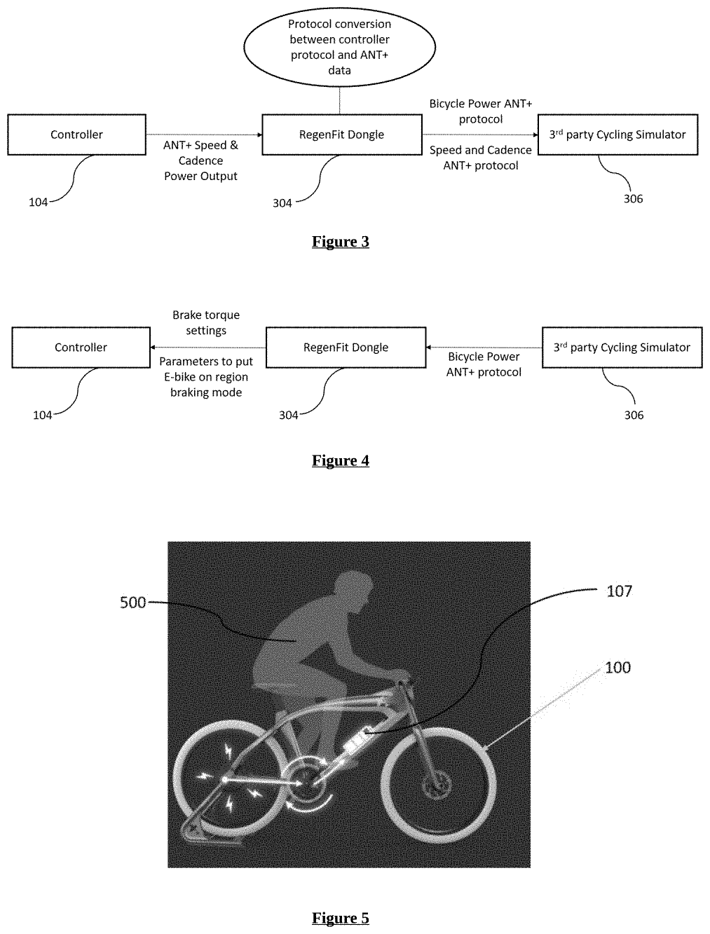

FIG. 3 illustrates a communication from controller of E-bike to a 3rd party Cycling Simulator via RegenFit Dongle of the present invention. As shown, the controller 104 sends Wheel Speed and Crank Speed of cycling speed according to wheel diameter in km/hr to RegenFit Dongle 304 for protocol conversion to ANT+ FEC standard. The RegenFit Dongle 304 sends Bicycle Power in ANT+ protocol and Speed and Cadence in ANT+ protocol to the 3^{rd} party cycling simulator 306. RegenFit Dongle 304 is used for protocol conversion between controller protocol and ANT+ data.

FIG. 4 illustrates a communication from a 3rd party Cycling Simulator via RegenFit Dongle to a controller of E-bike of the present invention. The RegenFit Dongle 304 sends same parameters as of the RegenFit App 204 to put E-bike in region braking mode. The dongle 304 also sets the brake torque settings to the controller 104 in real time in order to replicate the resistance given by the 3rd party Cycling Simulator 306 through the ANT+ bicycle power control. As an example, instruction from the dongle 304 can be 5% brake torque for flat ground and 20% brake torque for 30% hill inclination. UART is used to send/receive data to/from RegenFit Dongle 304.

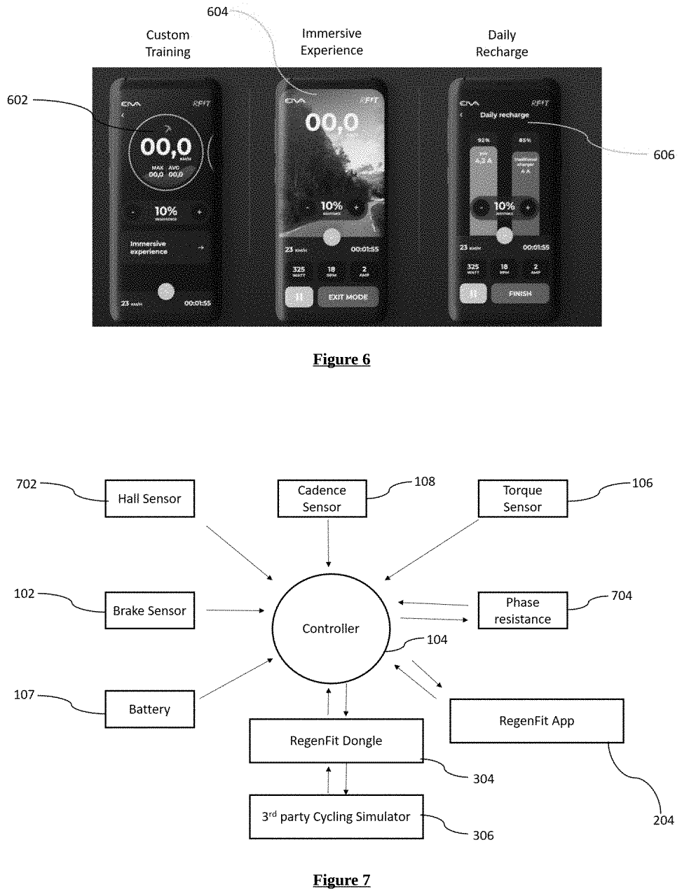

FIG. 5 illustrates a perspective view showing charging of battery of E-bike using electromagnetic field of the motor as per the disclosed structure. In the present invention, the electromagnetic field of the motor and hall sensors along with the torque and cadence sensors are used to recharge the battery 107 of the E-bike 100. The sensors also help a user 500 to connect to 3^{rd} party simulators and record data on a paired smartphone application.

FIG. 6 illustrates a perspective view showing different interfaces of the RegenFit App used in the present invention as per the disclosed structure. As shown, the RegenFit App offers three interfaces to meet requirements of a user. The application offers a custom training interface 602, an immersive experience interface 604 and a daily recharge interface 606 showing different details of the workout. A user can select one of the three interfaces as per the choice.

FIG. 7 illustrates control flow diagram between various components of the system of the present invention as per the disclosed structure. As shown, the controller 104 receives Pedal RPM data from cadence sensor 108. The controller 104 receives heel RPM data from hall sensor 702. the controller 104 receives Brake On/off data from brake sensor 102. the controller 104 receives crank pressure data from torque sensor 106. the controller 104 receives and send percentage of braking torque from and to Phase resistance 704. A BLE connection is made between the RegenFit App 204 and the controller 104. Voltage, power input and Charge current are received from battery by the controller 104. UART is used to send/receive data to/from RegenFit Dongle 304 by the controller 104 which in turn is connected to the 3rd party Cycling Simulator 306.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system to convert an E-bike into a smart trainer comprising:
an E-bike having at least a controller, a cadence sensor, a hall sensor, a battery, a brake sensor, a motor and a torque sensor;
a UART capable dongle to communicate with the controller wherein the dongle is used for converting controller data into ANT+ FEC standard;
a smartphone application connected to the controller using a Bluetooth Low Energy connection;
the UART capable dongle transfers data to a cycling simulator.

2. The system of claim 1, further converts the pedal assisted bike into an indoor smart trainer.

3. The system of claim 1, wherein the smartphone application displays the training data.

4. The system of claim 1, further uses electromagnetic field of the motor, torque sensors, cadence sensors and the hall sensors to recharge the battery of the E-bike.

5. A method to convert an E-bike into a smart trainer is disclosed and comprising the steps of:
mounting the E-bike onto a stand such that the rear wheel is free to roll;
connecting the E-bike through a Bluetooth signal to a smartphone application; and
broadcasting exercise related data to a third party cycling simulator after converting data to the standard ANT+ FEC protocol using a dongle.

6. The method of claim 5, further comprising disconnect the smartphone application and use the E-bike in a normal way.

7. The method of claim 5, further comprising recharge battery of E-bike using electromagnetic field of the motor, torque sensors, cadence sensors and the hall sensors.

8. A method to convert an E-bike into a smart trainer is disclosed and comprising the steps of:
using the regenerative brake torque as a resistance for working out;
using the regenerative brake torque as a resistance for recharging the battery of the E-bike; and
connecting the E-bike to a third-party virtual cycling software through the ANT+ protocol.

9. The method of claim 8, further comprising the step of sending wheel speed and crank speed from the E-bike to a UART capable dongle.

10. The method of claim 9, further comprising the step of transmitting the E-bike information to the virtual cycling software using ANT+ FEC protocol.
